(19) United States
(12) Patent Application Publication
(10) Pub. No.: US 2019/0057160 A1
(43) Pub. Date: Feb. 21, 2019

(54) MERIT-BASED ANONYMOUS CONTENT DISTRIBUTION

(71) Applicant: Advance Local Media LLC, New York, NY (US)

(72) Inventors: Lawrence Donoghue, Brooklyn, NY (US); Kevin Wong, Robbinsville, NJ (US); David Cohn, Berkeley, CA (US); Harris Novick, Mamaroneck, NY (US)

(21) Appl. No.: 16/104,543

(22) Filed: Aug. 17, 2018

Related U.S. Application Data
(60) Provisional application No. 62/546,755, filed on Aug. 17, 2017.

(51) Int. Cl. G06F 17/30

(52) U.S. Cl. CPC G06F 17/30867; G06Q 50/01; G06F 17/30991

(57) ABSTRACT

Merit-based anonymous content distribution. A computing device receives from a first client computing device associated with a first user, a request for a post of a plurality of posts. The computing device randomly selects a first post of the plurality of posts. The first post is provided to the first client computing device for presentation to the first user. A designation that ranks the first post is received from the first client computing device. It is subsequently determined to distribute the first post or inhibit distribution of the first post based in part on the designation.

### RELATED APPLICATIONS

This application claims the benefit of U.S. Provisional Patent Application No. 62/546,755, filed on Aug. 17, 2017, entitled “MERIT-BASED ANONYMOUS SOCIAL NETWORK,” the disclosure of which is hereby incorporated herein by reference in its entirety.

### TECHNICAL FIELD

The embodiments relate generally to the distribution of content in a social network, and in particular to merit-based anonymous content distribution.

### BACKGROUND

The term “post” as used herein refers to content such as text, an image, a video, an audio snippet, or the like, that one individual may desire another individual to view or hear. Conventional social networks allow users to submit their own posts, or redistribute other users' posts, to any number of recipients. Often, a user of such a social network receives many posts that are of little interest to the user, or, in all likelihood, of little interest to the majority of the recipients of the post. For example, a user may generate a post and send the post to a number of other users, and the majority of other users may find the post to be offensive, or not humorous, or not informative, or possessing some other deficiency. Over time, users of such social networks may lose interest in being a member of the social network because the effort it takes to review posts is not worth the benefit obtained by reading the posts.

### SUMMARY

The embodiments relate to merit-based anonymous content distribution where posts of users are randomly, and anonymously, distributed to other users based in part on user rankings of the posts. Higher ranked posts are distributed to a larger number of users than lower ranked posts. Ultimately, based on low user rankings, a post may be removed from the pool of posts. The embodiments thus facilitate the distribution of posts that are more highly ranked to a larger number of users, and limit lower ranked posts to a relatively small number of users.

In one embodiment a method is provided. The method includes receiving, by a computing device from a first client computing device associated with a first user, a request for a post of a plurality of posts. The method further includes randomly selecting, by the computing device, a first post of the plurality of posts. The method further includes providing the first post to the first client computing device for presentation to the first user. The method further includes receiving, from the first client computing device, a designation that ranks the first post. The method further includes subsequently determining to distribute the first post or inhibit distribution of the first post based in part on the designation.

In another embodiment a computing device is provided. The computing device includes a communication interface configured to communicate with a network, and a processor device coupled to the communication interface. The processor device is configured to receive, from a first client computing device associated with a first user, a request for a post of a plurality of posts. The processor device is further configured to randomly select a first post of the plurality of posts. The processor device is further configured to provide the first post to the first client computing device for presentation to the first user. The processor device is further configured to receive, from the first client computing device, a designation that ranks the first post. The processor device is further configured to subsequently determine to distribute the first post or inhibit distribution of the first post based in part on the designation.

In another embodiment a computer program product stored on a non-transitory computer-readable storage medium is provided. The computer program product includes instructions to cause a processor device to receive, from a first client computing device associated with a first user, a request for a post of a plurality of posts. The instructions further cause the processor device to randomly select a first post of the plurality of posts. The instructions further cause the processor device to provide the first post to the first client computing device for presentation to the first user. The instructions further cause the processor device to receive, from the first client computing device, a designation that ranks the first post. The instructions further cause the processor device to subsequently determine to distribute the first post or inhibit distribution of the first post based in part on the designation.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram illustrating an environment in which embodiments may be practiced;

FIG. 2 is a flowchart of a method for implementing merit-based anonymous content distribution according to one embodiment;

FIG. 3 is a diagram illustrating three successive periods of time and example interactions by a user with a client application according to one embodiment;

FIG. 4 is a message flow diagram illustrating in greater detail example processing that may take place in response to selection of a read control by the user;

FIG. 5 is a diagram illustrating three successive periods of time and example interactions by the user with the client application according to another embodiment;

FIG. 6 is a message flow diagram illustrating in greater detail example processing that may take place in response to selection of a post control by the user;

FIG. 7 is a diagram illustrating three successive periods of time and example interactions by the user with the client application according to another embodiment;

FIG. 8 is a message flow diagram illustrating in greater detail example processing that may take place in response to selection of a stats control by the user;

FIG. 9 is a flowchart of a method for subsequently determining to distribute a post or inhibit distribution of a post based in part on a designation received from a user in response to viewing the post, according to one embodiment; and

FIG. 10 is a block diagram of a computing device suitable for implementing examples disclosed herein.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first user” and “second user,” and does not imply a priority, a type, an importance, or other attribute, unless otherwise stated herein. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified.

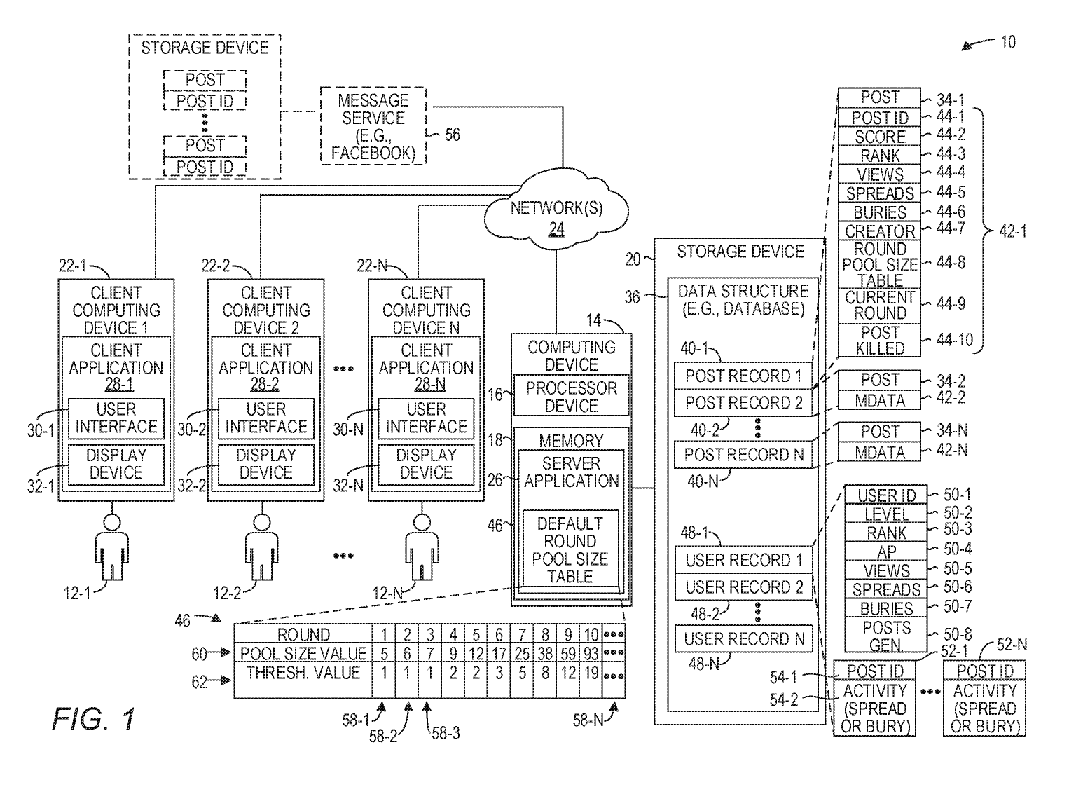

FIG. 1 is a block diagram illustrating an environment 10 in which embodiments may be practiced. The environment 10 may be referred to as a network (sometimes referred to as a “social network”), in which various users 12-1-12-N (generally, user 12 or users 12) may anonymously share content (i.e., text, an image, audio, video, or the like, and any combination thereof) in the form of a post with one another. The content is shared anonymously in that a user 12 is provided a post without an identification of which other user 12 generated, or originated the post.

In the embodiment shown in FIG. 1, the environment 10 includes a computing device 14 that includes a processor device 16 and a memory 18. The computing device 14 includes, or is communicatively coupled to a storage device 20. Each user 12 interacts with a corresponding client computing device 22-1-22-N (generally, client computing device 22 or client computing devices 22). The client computing devices 22 may comprise any suitable electronic device, such as a smartphone, computing tablet, laptop or desktop computer, or the like. Although not shown, each of the client computing devices 22 include a processor device and a memory. The client computing devices 22 are communicatively coupled to one another and the computing device 14 via one or more networks 24.

The computing device 14 includes a server application 26 which implements aspects of the anonymous merit-based content distribution discussed herein. Each of the client computing devices 22-1-22-N includes a client application 28-1-28-N with which a corresponding user 12-1-12-N may interact via one or more user interfaces 30-1-30-N that may be presented to the corresponding users 12-1-12-N on corresponding display devices 32-1-32-N (generally, display devices 32 or display devices 32).

Over time, the users 12, via the corresponding client applications 28, enter a plurality of posts 34-1-34-N (generally, post 34 or posts 34). The posts 34 are received by the computing device 14, and the server application 26 stores the posts 34 in a data structure 36 (e.g., such as a database) on one or more storage devices 20. For each post 34, the server application 26 generates a corresponding post record 40-1-40-N, which includes a particular post 34, and metadata 42-1-42-N (generally metadata 42) which comprises information about, or associated with, the particular post 34. The metadata 42-1 includes a post ID field that maintains a unique post ID 44-1 of the post 34-1. The metadata 42-1 includes a score field that maintains a score value 44-2 associated with the post 34-1. The score value 44-2 of the post 34-1 may be, for example, based on any desirable criteria by which it is desired to distinguish one post 34 from another post 34. In one embodiment, the score value 44-2 may be calculated in accordance with the following formula:
each view of the post 34-1 by a user 12=−1 points
each “spread” of the post 34-1 by a user 12=+3 points
each “bury” of the post 34-1 by a user 12=−1 points

Score value 44-2=((“number of views”)*−1)+((“number of spreads”)*3)+((“number of buries”)*−1)

Example: The post 34-1 has been viewed by four users 12, with three recorded curations: two spreads, one bury. The score value 44-2 for the post 34-1 would be derived as follows:

score value 44-2=(4*−1)+(2*3)+(1*−1)=−4+6−1=+1

As used herein, a “spread” refers to a designation (i.e., a curation) received from a user 12 who has viewed a particular post 34 via a corresponding client computing device 22 that indicates that the user 12 believes the corresponding post 34 should be distributed randomly to additional users 12. As used herein, a “bury” refers to a designation received from a user 12 who has viewed a particular post 34 via a corresponding client computing device 22 that indicates that the user 12 believes the corresponding post 34 should not be distributed randomly to additional users 12.

The metadata 42-1 includes a rank field that maintains a rank value 44-3 that indicates a ranking of the post 34-1 with respect to all other posts 34. The ranking may be made, for example, based on the corresponding score values 44-2 of each post 34.

As an example of content ranking, if there are five posts 34 that have the corresponding score values 44-2 indicated below, and if there are two posts 34 that have identical score values 44-2, then the rank values 44-3 for the corresponding posts 34 may be determined as follows:
based on a score value 44-2 of 100 for a first post 34, the rank value 44-3 of the first post 34 is 1 (i.e., rank 1);
based on a score value 44-2 of 80 for a second post 34, the rank value 44-3 for the second post 34 is 2 (i.e., rank 2);
based on a score value 44-2 of 80 for a third post 34, the rank value 44-3 for the third post 34 is 2 (i.e., rank 2, tied with the second post 34);
based on a score value 44-2 of 0 for a fourth post 34, the rank value 44-3 for the fourth post 34 is 3 (i.e., rank 3); and
based on a score value 44-2 of −20 for a fifth post 34, the rank value 44-3 for the fifth post 34 is 4 (i.e., rank 4).

In some examples, the rank value 44-3 may be provided to a user 12 as falling within a percentile tier as follows:
Top 5%
Top 10%
Top 15%
Top 25%
Top 50%
Bottom 50%

In some embodiments, percentile tiers are calculated from the rank values 44-3 of the total posts 34 as follows:

Percentile Tier=(rank value 44-3 of a post 34/number of total posts 34)*100

The metadata 42-1 includes a view field that maintains a views counter 44-4 that identifies the number of users 12 to which the post 34-1 has been randomly provided. The metadata 42-1 includes a counter field that maintains a spreads counter 44-5 that identifies the number of users 12 who have viewed the post 34-1 and designated that the post 34-1 should be distributed to additional users 12. The metadata 42-1 includes a buries counter field that maintains a buries counter 44-6 that identifies the number of users 12 who have viewed the post 34-1 and designated that the post 34-1 should not be distributed to additional users 12. The metadata 42-1 includes a creator field that maintains a creator identifier (ID) 44-7 that identifies the user 12 who generated the post 34-1. The creator ID 44-7 may be used by the server application 26, for example, to ensure that the post 34-1 is not randomly provided to the user 12 who created the post 34-1.

The metadata 42-1 includes a round pool size table field that maintains, or references, a round pool size table 44-8 that is used by the server application 26 to determine whether or not the post 34-1 should be further distributed to additional users 12, or should be “killed” and not provided to any additional users 12, in conjunction with curations (e.g., spreads and buries) received from users 12 who have viewed the post 34-1.

In one embodiment, the round pool size table 44-8 for each post 34 is generated from a default round pool size table 46 and from a user level associated with the user 12 that generated the particular post 34. Details on generating the round pool size table 44-8 and how it affects the distribution of a post 34 will be discussed in greater detail below. The metadata 42-1 includes a current round counter 44-9 that is used to keep track of a current round of the round pool size table 44-8. The metadata 42-1 includes a post killed field that maintains a post killed indicator 44-10 that, if set, indicates that the post 34-1 will not be distributed to any additional users 12.

The metadata 42-2 associated with the post 34-2 maintains the same metadata fields as discussed above with the metadata 42-1, except the values of such fields are based on the post 34-2. Similarly, the metadata 42-N associated with the post 34-N maintains the same metadata fields as discussed above with the metadata 42-1, except the values of such fields are based on the post 34-N.

The server application 26 also maintains a plurality of user records 48-1-48-N (generally, user record 48 or user records 48), each of which corresponds to a particular user 12-1-12-N, and which maintains information about the corresponding user 12. For example, the user record 48-1 corresponds to the user 12-1, and includes a user ID field that maintains a unique user ID 50-1 associated with the user 12-1. A user level field maintains a user level 50-2 associated with the user 12-1. The user level 50-2 may be derived for example, from activities of the user 12-1. In one embodiment, the user level 50-2 may be derived based on a combination of post actions (e.g., generation of new posts 34 by the user 12-1), spread actions (e.g., the number of times the user 12-1 has designated that a post 34 that was randomly distributed to the user 12-1 should be distributed to additional users 12), and bury actions (e.g., the number of times the user 12-1 has designated that a post 34 that was randomly distributed to the user 12-1 should not be distributed to additional users 12).

Each of these actions may be awarded action points (AP) as follows:
1 curation (1 spread or 1 bury)=1 AP
1 post=8 AP

Each user 12 may progressively “Level Up” with the accumulation of Action Points, with each user level having a predetermined minimum requirement of APs needed. In one embodiment, a Level Up Table may define user levels 50-2 in the following manner:
user level 1=1 AP
user level 2=8 AP
user level 3=16 AP
user level 4=32 AP
user level 5=48 AP
user level 6 and beyond=40 AP
*Note: there may be no user level cap

For each user level achieved, users are rewarded 1 XP. An XP is a unit defined as 0.2 fractional users (i.e., 1 XP=0.2 users), and is used in the generation of a round pool size table 44-8 for a particular post 34 generated by the particular user 12. Generally, higher user levels 50-2 reward users 12 by providing a greater audience exposure (i.e., will be distributed to a larger number of other users 12) for their posts 34.

The user record 48-1 also includes a user rank field that maintains a user rank 50-3 associated with the user 12-1. The user rank 50-3 is a comparison of all users 12 according to their user level 50-2. Users 12 who have achieved higher user levels 50-2 have larger user ranks 50-3. In the event of users 12 having identical user levels 50-2, the users 12 are assigned the same user rank 50-3. In some embodiments, the user rank 50-3 is based on total distinct ranks, not total users 12.

As an example, if there are five users 12, and two have identical user levels 50-2, corresponding user ranks 50-3 may have the following values:
first user 12 having a user level 50-1 of 100 corresponds to a user rank 50-3 of 1 (i.e., user rank #1);
second user 12 having a user level 50-1 of 80 corresponds to a user rank 50-3 of 2 (i.e., user rank #2);
third user 12 having a user level 50-1 of 80 corresponds to a user rank 50-3 of 2 (i.e., user rank #2, tied with the second user);
fourth user 12 having a user level 50-1 of 60 corresponds to a user rank 50-3 of 3 (i.e., user rank #3); and
fifth user 12 having a user level 50-1 of 40 corresponds to a user rank 50-3 of 4 (i.e., user rank #4).

The user record 48-1 includes an action point field that maintains an action point value 50-4 that reflects the number of action points, as discussed above, awarded to the user 12-1. A views field maintains a views counter 50-5 that maintains a count of the number of posts 34 that have been randomly distributed to the user 12-1. A spreads field maintains a spreads counter 50-6 that maintains a count of the number of times the user 12-1 has designated that a post 34 should be distributed to other users 12. A buries field maintains a buries counter 50-7 that maintains a count of the number of times the user 12-1 has designated that a post 34 should not be distributed to other users 12. A posts generated field maintains a posts generated counter 50-8 that identifies a number of posts 34 that the user 12-1 has generated.

The user record 48-1 may also include a plurality of post records 52-1-52-N, each of which maintains information about a post 34 that has been randomly provided to the user 12-1, as well as the action taken with regard to the corresponding post 34 by the user 12-1. For example, the post record 52-1 includes a post ID field 54-1 that identifies a post 34 by the post ID 44-1 of the post 34. The post record 52-1 includes an activity field 54-2 that indicates the curation (i.e., spread or bury) designated by the user 12-1 after viewing the post 34 identified in the post ID field 54-1.

It is noted that while, solely for purposes of illustration, the server application 26 is described as implementing the functionality and information described above, in other embodiments the server application 26 may operate in conjunction with a message service 56, such as Facebook®. In such examples, the server application 26 may be developed to utilize message exchange protocols with the message service 56 to exchange information with the message service 56. In a Facebook example, the server application 26 may comprise a Facebook Messenger Chatbot, for example. Also in such examples, some of the information described as being maintained by the server application 26 in the data structure 36 may be maintained by the message service 56. For example, the message service 56 may maintain the posts 34, and the server application 26 may maintain some or all of the metadata 42 associated with the posts 34. The server application 26 and the message service 56 may refer to posts using the post IDs 44-1.

As discussed above, in some embodiments, the server application 26 maintains a round pool size table 44-8 to determine whether or not a respective post 34 should be further distributed to additional users 12, or should be “killed” and not provided to any additional users 12, in conjunction with curations (e.g., spreads and buries) received from users 12 who have viewed the respective post 34. In one embodiment, each round pool size table 44-8 is generated for a respective post 34 in accordance with the following procedure. The server application 26 accesses the default round pool size table 46. The default round pool size table 46 may correspond to a user 12 who has a user level 50-2 of zero. The default round pool size table 46 contains a plurality of columns 58-1-58-N, each of which corresponds to a particular, successive, round. Each round identifies a pool size value 60, and a threshold value 62. In some examples, the default pool size values 60 may be based on modified Fibonacci sequences. The threshold values 62, in some embodiments, are approximately 20 percent of the pool size value 60 of the respective round. There is no cap to the number of rounds. When a user 12 generates a post 34, the server application 26 accesses the default round pool size table 46 and adjusts the default pool size values 60 according to the following formula to generate the round pool size table 44-8 for the respective post 34:

Adjusted Pool Size per Round=“default Pool Size value”+(user level 50-2 of the user 12 generating the post 34)*0.2

Use of the round pool size table 44-8 for a respective post 34 will be discussed in greater detail below.

It should be noted that because the server application 26 is a component of the computing device 14, functionality implemented by the server application 26 may be attributed to the computing device 14 generally. Moreover, in examples where the server application 26 comprises software instructions that program the processor device 16 to carry out functionality discussed herein, functionality implemented by the server application 26 may be attributed herein to the processor device 16.

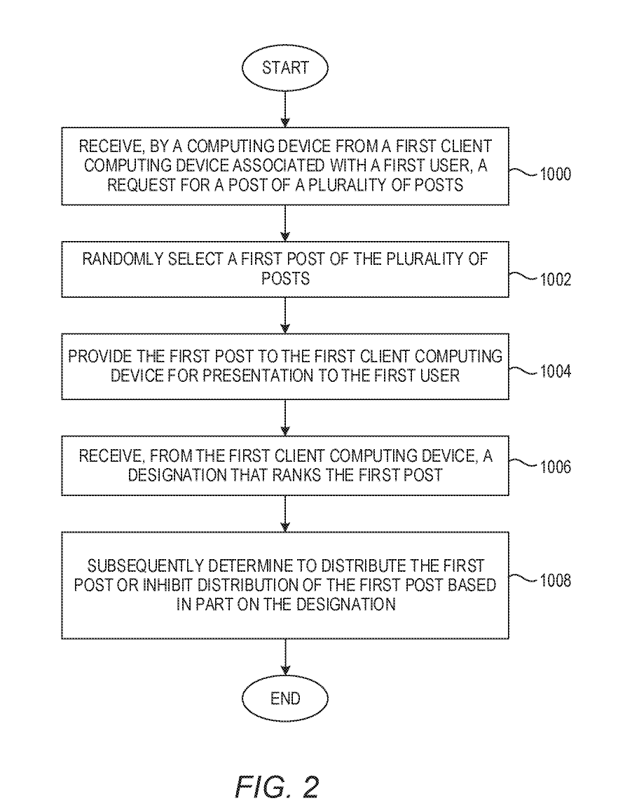

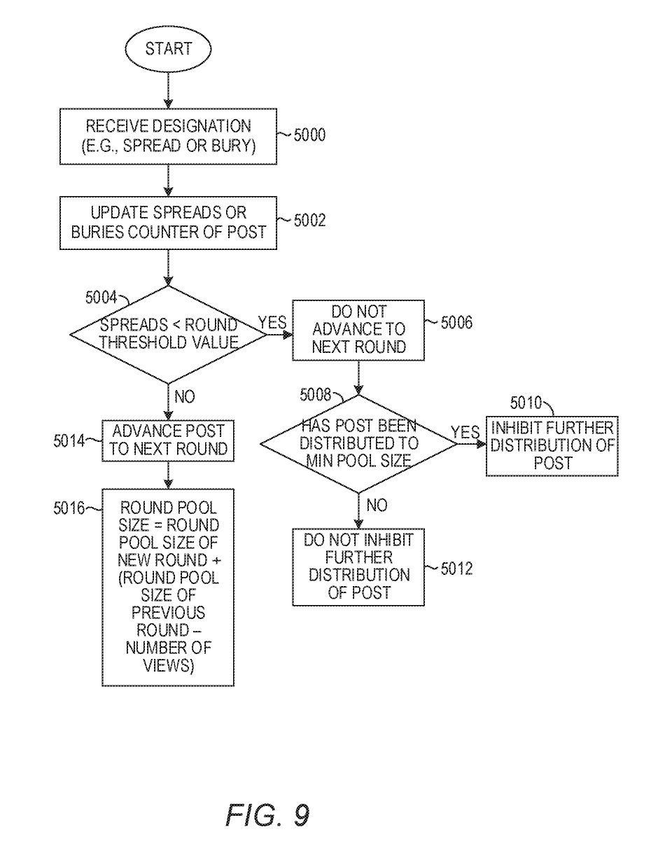

FIG. 2 is a flowchart of a method for implementing merit-based anonymous content distribution according to one embodiment. FIG. 2 will be discussed in conjunction with FIG. 1. The computing device 14 receives from the client computing device 22-1 associated with the user 12-1, a request for a post 34 of the plurality of posts 34 (FIG. 2, block 1000). The computing device 14 randomly selects, for example, the post 34-1 of the plurality of posts 34 (FIG. 2, block 1002). The random selection may take any random form, such as using a random number generator and scaling the received random number to a total number of posts 34. The computing device 14 provides the post 34-1 to the client computing device 22-1 for presentation to the user 12-1 (FIG. 2, block 1004). The computing device 14 receives, from the client computing device 22-1 a designation that ranks the post 34-1 (FIG. 2, block 1006). For example, the designation may rank the post 34-1 by indicating that the post 34-1 should be “spread” to other users 12. Alternatively, the designation may rank the post 34-1 by indicating that the post 34-1 should be “buried” and not distributed to other users 12. While the embodiments disclosed herein discuss the designations as “spread” or “bury,” it will be apparent that any other designations could be used to rank the posts 34, such as a numeric designation, alphabetical designation, or any other designations capable of expressing a preference or lack thereof for a particular post 34. The computing device 14 subsequently determines to distribute the post 34-1 or inhibit distribution of the post 34-1 based in part on the designation (FIG. 2, block 1008). In particular, as will be discussed below with regard to FIG. 9, after receiving a designation from the user 12-1, the client computing device 22-1 analyzes the post 34-1 and makes a determination such as whether or not to allow the post 34-1 to continue to be distributed.

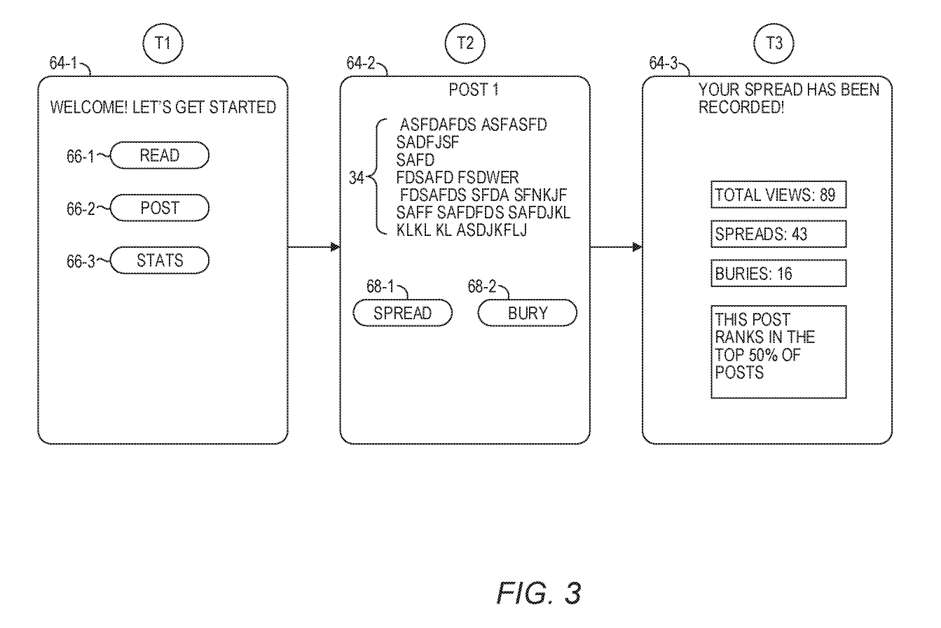

FIG. 3 is a diagram illustrating three successive periods of time and example interactions by the user 12-1 with the client application 28-1 according to one embodiment. Initially, the user 12-1 may initiate the client application 28-1 on the client computing device 22-1. The client application 28-1 may, for example, be a local application, or may be provided over the network 24 via a browser, or the like. At a time T1, the client application 28-1 presents a user interface 64-1 on the display device 32-1. The user interface 64-1 presents a read control 66-1, a post control 66-2, and a stats control 66-3 to the user 12-1. In this example the user 12-1 selects the read control 66-1. The client application 28-1 sends a message to the server application 26 that requests a post 34, and includes the user ID 50-1 that uniquely identifies the user 12-1. The server application 26 randomly selects a post 34, ensures that the post 34 was not generated by the user 12-1 and has not been previously distributed to the user 12-1, and sends the post 34 to the user 12-1. Note that the post 34 is sent anonymously, without any designation as to which user 12 created the respective post 34.

At a time T2 the client application 28-1 receives the post 34 and presents a user interface 64-2 on the display device 32-1. The user interface 64-2 presents the post 34 to the user 12-1, but contains no information about the user 12 that originally created the post 34. The user interface 64-2 includes a spread control 68-1 and a bury control 68-2. The spread control 68-1 allows the user 12-1 to designate that the post 34 should be further distributed to other users 12 (randomly), and the bury control 68-2 allows the user 12-1 to designate that the post 34 should not be further distributed to other users 12. In this example the user 12-1 selects the spread control 68-1.

The client application 28-1 sends a message to the server application 26 that indicates that the user 12-1 selected the spread control 68-1 with respect to the post 34. The server application 26 receives the message, stores information that indicates that the user 12-1 selected the spread control 68-1 with respect to the post 34, generates a response to confirm receipt of the designation, and sends the response to the client application 28-1. In some embodiments, the response may include statistics associated with the respective post 34, such as the total views of the respective post 34 by all users 12, the total “spread” designations of users 12 who viewed the respective post 34, the total “bury” designations of users 12 who viewed the respective post 34, and the ranking of the post 34. The client application 28-1 receives the message from the server application 26 and presents a user interface 64-3 that presents the response to the user 12-1.

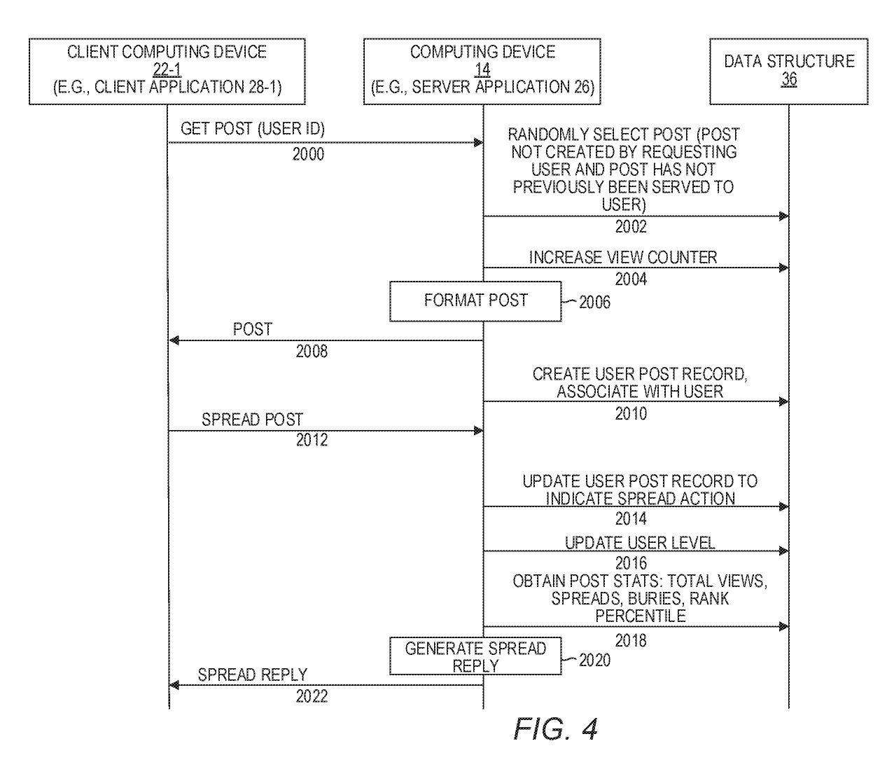

FIG. 4 is a message flow diagram illustrating in greater detail example processing that may take place in response to selection of the read control 66-1 (FIG. 3) by the user 12-1. Initially the client computing device 22-1 sends a message to the computing device 14 requesting a random post 34 for the user 12-1 (step 2000). The computing device 14 accesses the data structure 36 to randomly select a post 34, and ensures that the randomly selected post 34 was not generated by the user 12-1 and was not previously sent to the user 12-1. For example, the computing device 14 can determine that the creator ID 44-7 of the selected post 34 does not match the user ID 50-1 of the user 12-1. The computing device 14 can also access the post records 52 of the user 12-1 to verify that the selected post 34 was not previously provided to the user 12-1. If one of these conditions is not met, the computing device 14 successively randomly selects posts 34 until both conditions are met (step 2002). After selection of the post 34, the computing device 14 increases the views counter 44-4 of the respective post 34 (step 2004).

The computing device 14 formats the post 34 and sends the post 34 to the client computing device 22-1 (steps 2006-2008). The computing device 14 also generates a post record 52 that identifies the post 34 and stores the post record 52 in the data structure 36 (step 2010). In this example, the client computing device 22-1 presents the post 34 to the user 12 and receives a spread designation from the user 12-1 (not illustrated). The client computing device 22-1 sends a message to the computing device 14 that indicates the spread designation made by the user 12-1 (step 2012). The computing device 14 updates the post record 52 to indicate that the user 12-1 indicated a spread designation (i.e., spread action) (step 2014). The computing device 14 also updates the user level 50-2 of the user 12-1, if appropriate, in accordance with the formulas discussed above (step 2016). The computing device 14 may then obtain, from the metadata 42 associated with the post 34, various statistical information, such as the total views of the respective post 34 by all users 12, the total “spread” designations of users 12 who viewed the respective post 34, the total “bury” designations of users 12 who viewed the respective post 34, and the ranking of the post 34 (step 2018). The computing device 14 formats a reply, and sends the reply to the client computing device 22-1 (steps 2020-2022). The client computing device 22-1 receives the message from the computing device 14 and presents the user interface 64-3 (FIG. 3) that presents the response to the user 12-1.

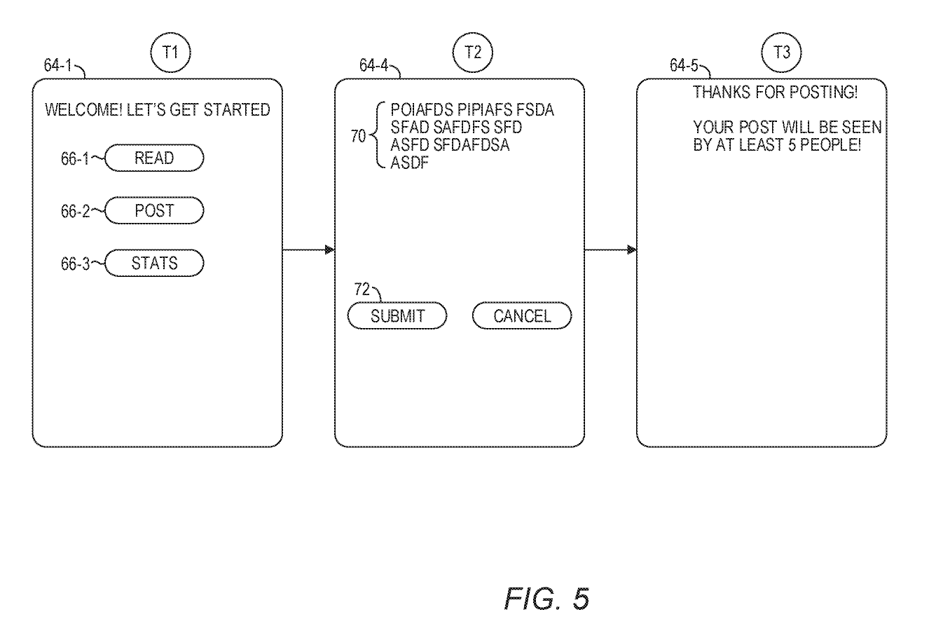

FIG. 5 is a diagram illustrating three successive periods of time and example interactions by the user 12-1 with the client application 28-1 according to another embodiment. In this embodiment, at a time T1 the client application 28-1 presents the user interface 64-1 on the display device 32-1. The user interface 64-1 presents the read control 66-1, the post control 66-2, and the stats control 66-3 to the user 12-1. In this example the user 12-1 selects the post control 66-2. In response, at a time T2, the client application 28-1 presents a user interface 64-4 to the user 12-1. The user 12-1 enters, such as via a keyboard, a message 70, and selects a submit control 72. The client application 28-1 sends the message 70 to the computing device 14 as a new post 34. The computing device 14 receives the message 70 and generates a new post 34 in the data structure 36. The computing device 14 generates a round pool size table 44-8 for the new post 34, and based on the derived pool size value 60 for the first round, generates a message indicating the minimum number of users 12 that will view the new post 34, and sends the message to the client application 28-1. The client application 28-1 receives the message from the server application 26, and at a time T3, presents a user interface 64-5 that presents a response to the user 12-1.

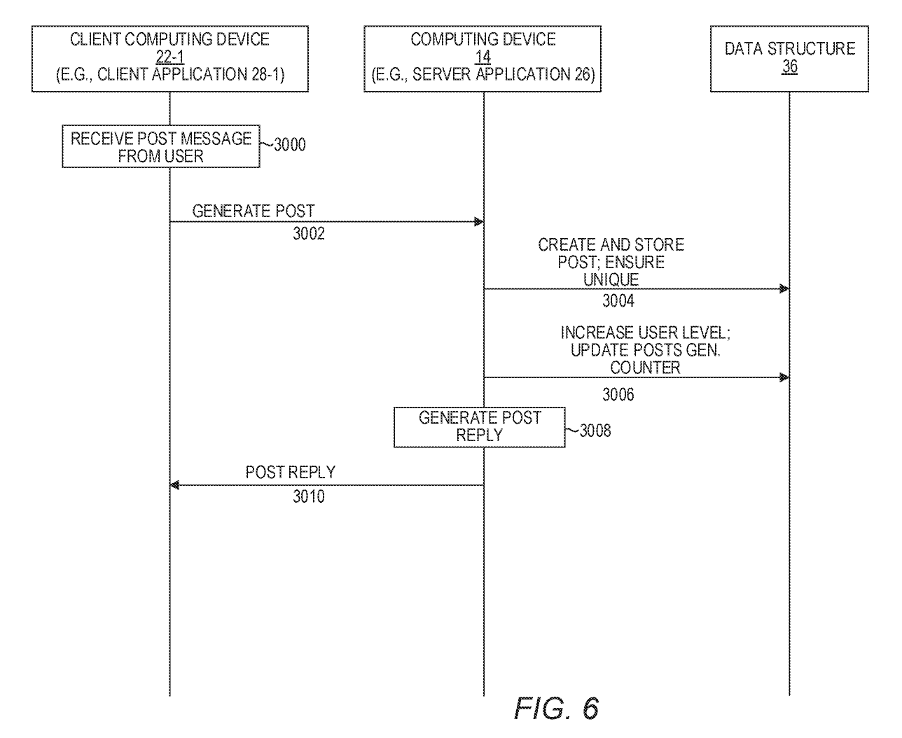

FIG. 6 is a message flow diagram illustrating in greater detail example processing that may take place in response to selection of the post control 66-2 (FIG. 5) by the user 12-1. Initially the client computing device 22-1 receives the message 70 from the user 12-1, as discussed above with regard to FIG. 5 (step 3000). The client computing device 22-1 sends the message 70 to the computing device 14 indicating that the message 70 represents a new post (step 3002). The computing device 14 creates and stores a new post 34 in the data structure 36 (step 3004). In some embodiments, the computing device 14 may first verify that the message is unique prior to generating the new post 34. The computing device 14 also increments the posts generated counter 50-8, and updates the user level 50-2 of the user 12-1, if appropriate, in accordance with the formulas discussed above (step 3006). The computing device 14 generates a post reply, which, as discussed above, may identify the minimum number of users 12 who will view the post 34, and sends the post reply to the client computing device 22-1 (steps 3008-3010). The client computing device 22-1 receives the post reply from the computing device 14 and presents the user interface 64-5 (FIG. 3) that presents the post reply to the user 12-1.

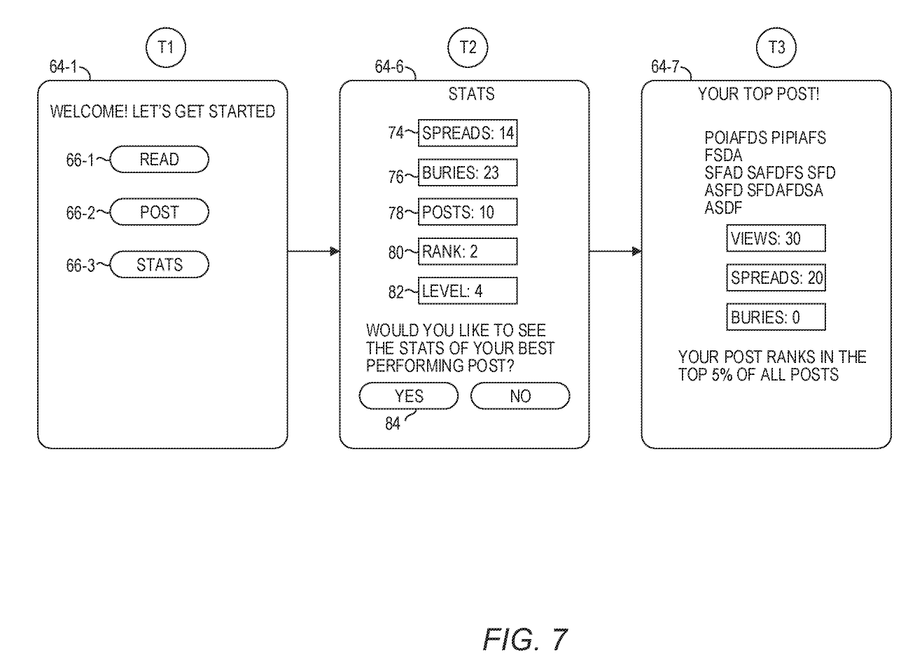

FIG. 7 is a diagram illustrating three successive periods of time and example interactions by the user 12-1 with the client application 28-1 according to another embodiment. In this embodiment, at a time T1 the client application 28-1 presents the user interface 64-1 on the display device 32-1. The user interface 64-1 presents the read control 66-1, the post control 66-2, and the stats control 66-3 to the user 12-1. In this example the user 12-1 selects the stats control 66-3. In response, the client application 28-1 sends a message to the server application 26 requesting statistics associated with the user 12-1. The server application 26 obtains various statistics regarding the user 12-1, generates a message that identifies the statistics, and sends the message to the client application 28-1. At a time T2, the client application 28-1 presents a user interface 64-6 that identifies the various statistics. In this example, the user interface 64-6 includes a message area 74 that identifies the value of the spreads counter 50-6 of the user record 48-1, a message area 76 that identifies the value of the buries counter 50-7 of the user record 48-1, a message area 78 that identifies the number of posts 34 generated by the user 12-1, a message area 80 that identifies the user rank 50-3 of the user record 48-1, and a message area 82 that identifies the user level 50-2 of the user record 48-1.

In one embodiment, the user interface 64-6 may also permit the user 12-1 to view the statistics of the best performing post of the user 12-1 upon selection of a control 84. In response to a selection of the control 84, the client application 28-1 sends a message to the server application 26 and requests the statistics of the best performing post 34 of the user 12-1. The server application 26 analyzes the posts 34 generated by the user 12-1 to determine which post 34 was the best performing post 34, and then generates a message that contains the post 34, as well as the number of views of the post 34 by other users 12, the number of spread designations received by the other users 12, and the number of bury designations received by the other users 12. The message also indicates the ranking of the post 34. The server application 26 sends the message to the client application 28-1. At a time T3, the client application 28-1 receives the message and presents the message in a user interface 64-7.

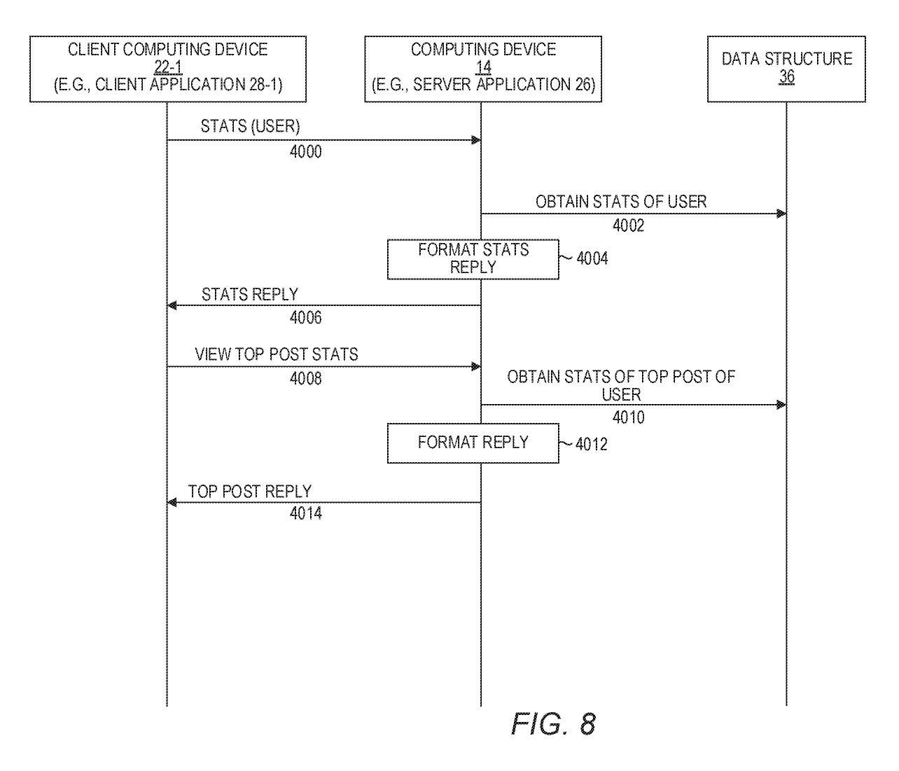

FIG. 8 is a message flow diagram illustrating in greater detail example processing that may take place in response to selection of the stats control 66-3 (FIG. 7) by the user 12-1. Initially the client computing device 22-1 receives the selection of the stats control 66-3 from the user 12-1, and sends a stats request message that includes the user ID of the user 12-1 to the computing device 14 (step 4000). The computing device 14 obtains the stats for the user 12-1 from the data structure 36 (step 4002). For example, as discussed above with regard to FIG. 7, the computing device 14 obtains the value of the spreads counter 50-6 of the user record 48-1, the value of the buries counter 50-7 of the user record 48-1, determines the number of posts 34 generated by the user 12-1, the user rank 50-3 of the user record 48-1, and the user level 50-2 of the user record 48-1. The computing device 14 formats a stats reply, and sends the stats reply to the client computing device 22-1 (steps 4004-4006). The client computing device 22-1 presents the statistics in the user interface 64-6, as illustrated in FIG. 7. The client computing device 22-1 receives the indication that the user 12-1 would like to view the statistics of the top performing post 34 of the user 12-1. In response to the selection of the control 84 by the user 12-1 (FIG. 7), the client computing device 22-1 sends a message to the computing device 14 and requests the statistics of the best performing post 34 of the user 12-1 (step 4008). The computing device 14 analyzes the posts 34 generated by the user 12-1 to determine which post 34 was the best performing post 34, and then generates a message that contains the post 34, as well as the number of views of the post 34 by other users 12, the number of spread designations received by the other users 12, and the number of bury designations received by the other users 12 (steps 4010-4012). The computing device 14 sends the message to the client computing device 22-1 for presentation to the user 12-1 (step 4014).

FIG. 9 is a flowchart of a method for subsequently determining to distribute a post 34 or inhibit distribution of a post 34 based in part on a designation received from a user 12 in response to viewing the post 34, according to one embodiment. The method being upon receipt of a user designation, such as a spread designation or a block designation, by a user 12-1 in response to being provided a post 34 (block 5000). The server application 26 updates the appropriate metadata maintained in the data structure 36, such as the appropriate spreads counter 44-5 or buries counter 44-6 of the post 34 (block 5002). Although not illustrated, the server application 26 may also update appropriate metadata 50 of the corresponding user record 48 to reflect the designation by the user 12.

The server application 26 determines whether the value of the spreads counter 44-5 of the post 34 is less than the round threshold value 62 identified in the current round counter 44-9 of the round pool size table 44-8 of the post 34 (block 5004). In other words, the server application 26 determines whether there is a sufficient number of “spread” designations to advance the post 34 to a next round. If the value of the spreads counter 44-5 of the post 34 is less than the round threshold value 62 identified in the current round counter 44-9 of the round pool size table 44-8 of the post 34, then there is not a sufficient number of spread designations to advance the post 34 to the next round (block 5006). The server application 26 determines if the post 34 has been distributed to the number of users 12 identified in the pool size value 60 of the current round counter 44-9 of the round pool size table 44-8 of the post 34 (block 5008). If so, the server application 26 inhibits further distribution of the post 34 (block 5010). In one embodiment, the server application 26 sets the post killed indicator 44-10.

If the post 34 has not been distributed to the number of users 12 identified in the pool size value 60 of the current round counter 44-9 of the round pool size table 44-8 of the post 34, the server application 26 allows the post 34 to be further randomly distributed to additional users 12 (block 5012).

If, at block 5004, the server application 26 determines that the value of the spreads counter 44-5 of the post 34 is greater than or equal to the round threshold value 62 identified in the current round counter 44-9 of the round pool size table 44-8 of the post 34, the server application 26 advances the post 34 to the next round (block 5014). In particular, the server application 26 increments the current round counter 44-9. The server application 26 also determines whether or not the post 34 had been distributed to the minimum number of users 12 identified in the pool size value 60 for the previous round. If not, the server application 26 determines a difference value that identifies the difference between the designated minimum number of users 12 identified in the pool size value 60 for the previous round and the actual number of users 12 to which the post 34 was distributed, and adds the difference value to the existing pool size value 60 of the current round of the round pool size table 44-8 as identified by the current round counter 44-9 (block 5016).

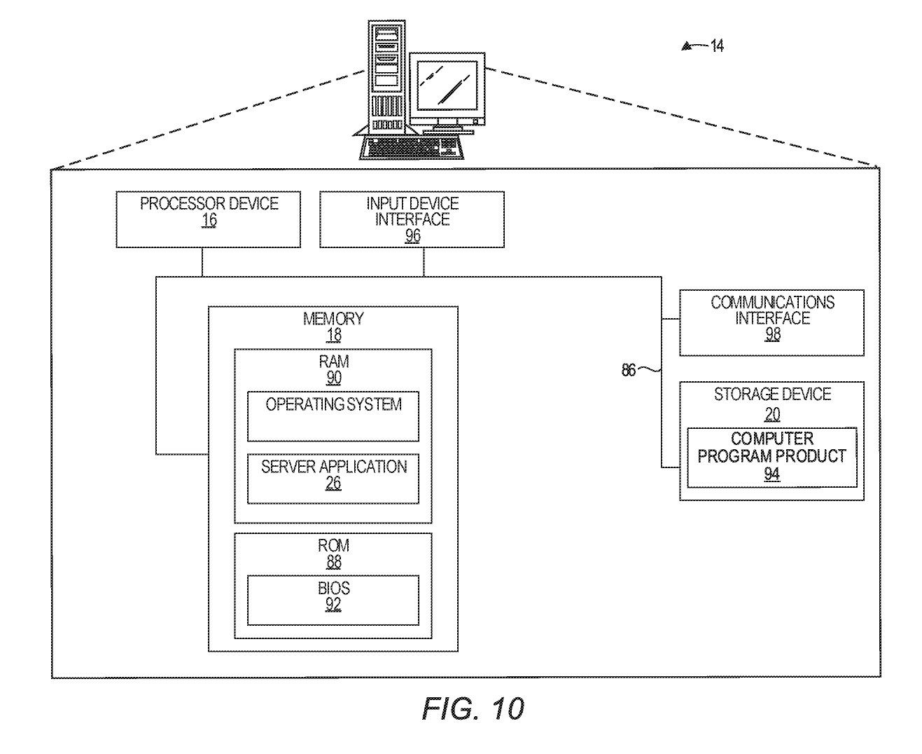

FIG. 10 is a block diagram of the computing device 14 suitable for implementing examples disclosed herein. The computing device 14 may comprise any computing or electronic device capable of including firmware, hardware, and/or executing software instructions to implement the functionality described herein, such as a computer server, a desktop computing device, a laptop computing device, or the like. The computing device 14 includes the processor device 16, the memory 18, and a system bus 86. The system bus 86 provides an interface for system components including, but not limited to, the memory 18 and the processor device 16. The processor device 16 can be any commercially available or proprietary processor.

The system bus 86 may be any of several types of bus structures that may further interconnect to a memory bus (with or without a memory controller), a peripheral bus, and/or a local bus using any of a variety of commercially available bus architectures. The memory 18 may include non-volatile memory 88 (e.g., read-only memory (ROM), erasable programmable read-only memory (EPROM), electrically erasable programmable read-only memory (EEPROM), etc.), and volatile memory 90 (e.g., random-access memory (RAM)). A basic input/output system (BIOS) 92 may be stored in the non-volatile memory 88 and can include the basic routines that help to transfer information between elements within the computing device 14. The volatile memory 90 may also include a high-speed RAM, such as static RAM, for caching data.

The computing device 14 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 20 and other drives associated with computer-readable media and computer-usable media may provide non-volatile storage of data, data structures, computer-executable instructions, and the like. The storage device 20 may also contain computer-executable instructions for performing novel methods of the disclosed examples.

A number of modules can be stored in the storage device 20 and in the volatile memory 90, including an operating system and one or more program modules, such as the server application 26, which may implement the functionality described herein in whole or in part.

All or a portion of the examples may be implemented as a computer program product 94 stored on a transitory or non-transitory computer-usable or computer-readable storage medium, such as the storage device 20, which includes complex programming instructions, such as complex computer-readable program code, to cause the processor device 16 to carry out the steps described herein. Thus, the computer-readable program code can comprise software instructions for implementing the functionality of the examples described herein when executed on the processor device 16. The processor device 16, in conjunction with the server application 26 in the volatile memory 90, may serve as a controller, or control system, for the computing device 14 that is to implement the functionality described herein.

An operator may also be able to enter one or more configuration commands through a keyboard (not illustrated) or a pointing device such as a mouse (not illustrated). Such input devices may be connected to the processor device 16 through an input device interface 96 that is coupled to the system bus 86 but can be connected by other interfaces such as a parallel port, an Institute of Electrical and Electronic Engineers (IEEE) 1394 serial port, a Universal Serial Bus (USB) port, an IR interface, and the like.

The computing device 14 may also include a communications interface 98 suitable for communicating with the network 24 as appropriate or desired.

Among other advantages, the embodiments facilitate the distribution of posts that are more highly ranked to a larger number of users, and limit lower ranked posts to a relatively small number of users.

Those skilled in the art will recognize improvements and modifications to the preferred embodiments of the disclosure. All such improvements and modifications are considered within the scope of the concepts disclosed herein and the claims that follow.

What is claimed is:

1. A method for distributing content, comprising:
receiving, by a computing device from a first client computing device associated with a first user, a request for a post of a plurality of posts;
randomly selecting, by the computing device, a first post of the plurality of posts;
providing the first post to the first client computing device for presentation to the first user;
receiving, from the first client computing device, a designation that ranks the first post; and
subsequently determining to distribute the first post or inhibit distribution of the first post based in part on the designation.

2. The method of claim 1 wherein providing the first post to the first client computing device for presentation to the first user further comprises providing the first post to the first client computing device for presentation to the first user without any data that identifies a user who originally generated the first post.

3. The method of claim 1 wherein the designation that ranks the first post comprises a designation to further distribute the first post, or a designation to halt subsequent distribution of the first post.

4. The method of claim 1 further comprising:
determining, prior to providing the first post to the first client computing device for presentation to the first user, that the first post was not submitted by the first user.

5. The method of claim 1 further comprising:
determining, prior to providing the first post to the first client computing device for presentation to the first user, that the first post was not previously provided to the first client computing device for presentation to the first user.

6. The method of claim 1 further comprising:
receiving, from the first client computing device, a second post;
storing the second post with the plurality of posts;
accessing user information that identifies a user level of the first user; and
based at least in part on the user level of the first user, generating a round pool size table for the second post that identifies for each of a plurality of rounds:
a user pool size value that identifies a number of users of a plurality of users to whom the second post will be randomly provided upon request; and
a threshold value that identifies a number of designations to further distribute the second post that must be received before the second post advances to a next round.

7. The method of claim 6 further comprising:
increasing, based on receiving the second post, the user level of the first user.

8. The method of claim 1 further comprising:
increasing, based on receiving the designation that ranks the first post, a user level of the first user.

9. The method of claim 1 further comprising:
incrementing a view counter associated with the first post that maintains a count of a number of users of the plurality of users to which the first post has been provided.

10. The method of claim 1 wherein subsequently determining to distribute the first post or inhibit distribution of the first post based in part on the designation comprises:
determining that the designation indicates that the first post should be further distributed;
incrementing a spread counter associated with the first post that maintains a count of a number of designations that indicate that the first post should be further distributed;
comparing the spread counter to a threshold value associated with a current round of the first post; and
based on comparing the spread counter to the threshold value, determining to further distribute the first post.

11. The method of claim 1 wherein subsequently determining to distribute the first post or inhibit distribution of the first post based in part on the designation comprises:
determining that the designation indicates that the first post should not be further distributed;
incrementing a bury counter associated with the first post that maintains a count of a number of designations that indicate that the first post should not be further distributed;
comparing a spread counter to a threshold value associated with a current round of the first post;
determining that the spread counter is less than the threshold value;
determining that the first post has been provided to a minimum number of users; and
based on determining that the spread counter is less than the threshold value and that the first post has been provided to a minimum number of users, identifying the first post as a post not to be further distributed.

12. The method of claim 1 further comprising:
receiving, by the computing device from a second client computing device associated with a second user, a request for a post of the plurality of posts;
randomly selecting the first post;
determining that the first post has not been previously provided to the second client computing device;
in response to determining that the first post has not been previously provided to the second client computing device, providing the first post to the second client computing device for presentation to the second user; and
incrementing a view counter that identifies a number of users to whom the first post has been distributed.

13. A computing device for distributing content, comprising:
a communication interface configured to communicate with a network; and
a processor device coupled to the communication interface and configured to:
receive, from a first client computing device associated with a first user, a request for a post of a plurality of posts;
randomly select a first post of the plurality of posts;
provide the first post to the first client computing device for presentation to the first user;
receive, from the first client computing device, a designation that ranks the first post; and
subsequently determine to distribute the first post or inhibit distribution of the first post based in part on the designation.

14. The computing device of claim 13 wherein to provide the first post to the first client computing device for presentation to the first user, the processor device is further configured to provide the first post to the first client computing device for presentation to the first user without any data that identifies a user who originally generated the first post.

15. The computing device of claim 13 wherein to subsequently determine to distribute the first post or inhibit distribution of the first post based in part on the designation, the processor device is further configured to:
determine that the designation indicates that the first post should be further distributed;
increment a spread counter associated with the first post that maintains a count of a number of designations that indicate that the first post should be further distributed;
compare the spread counter to a threshold value associated with a current round of the first post; and
based on comparing the spread counter to the threshold value, determine to further distribute the first post.

16. The computing device of claim 13 wherein to subsequently determine to distribute the first post or inhibit distribution of the first post based in part on the designation, the processor device is further configured to:
determine that the designation indicates that the first post should not be further distributed;
increment a bury counter associated with the first post that maintains a count of a number of designations that indicate that the first post should not be further distributed;
compare a spread counter to a threshold value associated with a current round of the first post;
determine that the spread counter is less than the threshold value;
determine that the first post has been provided to a minimum number of users; and
based on determining that the spread counter is less than the threshold value and that the first post has been provided to a minimum number of users, identify the first post as a post not to be further distributed.

17. The computing device of claim 13 wherein the processor device is further configured to:
receive, from a second client computing device associated with a second user, a request for a post of the plurality of posts;
randomly select the first post;
determine that the first post has not been previously provided to the second client computing device;
in response to determining that the first post has not been previously provided to the second client computing device, provide the first post to the second client computing device for presentation to the second user; and
increment a view counter that identifies a number of users to whom the first post has been distributed.

18. A computer program product stored on a non-transitory computer-readable storage medium and including instructions to cause a processor device to:
receive, from a first client computing device associated with a first user, a request for a post of a plurality of posts;
randomly select a first post of the plurality of posts;
provide the first post to the first client computing device for presentation to the first user;
receive, from the first client computing device, a designation that ranks the first post; and
subsequently determine to distribute the first post or inhibit distribution of the first post based in part on the designation.

19. The computer program product of claim 18 wherein to provide the first post to the first client computing device for presentation to the first user, the instructions further cause the processor device to provide the first post to the first client computing device for presentation to the first user without any data that identifies a user who originally generated the first post.

20. The computer program product of claim 18 wherein to subsequently determine to distribute the first post or inhibit distribution of the first post based in part on the designation, the instructions further cause the processor device to:
determine that the designation indicates that the first post should be further distributed;
increment a spread counter associated with the first post that maintains a count of a number of designations that indicate that the first post should be further distributed;
compare the spread counter to a threshold value associated with a current round of the first post; and
based on comparing the spread counter to the threshold value, determine to further distribute the first post.

21. The computer program product of claim 18 wherein to subsequently determine to distribute the first post or inhibit distribution of the first post based in part on the designation, the instructions further cause the processor device to:
determine that the designation indicates that the first post should not be further distributed;
increment a bury counter associated with the first post that maintains a count of a number of designations that indicate that the first post should not be further distributed;
compare a spread counter to a threshold value associated with a current round of the first post;
determine that the spread counter is less than the threshold value;
determine that the first post has been provided to a minimum number of users; and
based on determining that the spread counter is less than the threshold value and that the first post has been provided to a minimum number of users, identify the first post as a post not to be further distributed.
